(19) United States
(12) Patent Application Publication
(10) Pub. No.: US 2013/0076306 A1
(43) Pub. Date: Mar. 28, 2013

(54) WIRELESS POWER TRANSMISSION SYSTEM

(71) Applicant: SAMSUNG ELECTRO-MECHANICS CO., LTD., Gyunggi-do (KR)

(72) Inventors: Kwang Du Lee, Gyeonggi-do (KR); Young Seok Yoon, Gyeonggi-do (KR); Sam Ki Jung, Gyeonggi-do (KR); Jeong Ho Yoon, Gyeonggi-do (KR); Hyun Seok Lee, Seoul (KR); Jun Ki Min, Gyeonggi-do (KR); Eung Ju Kim, Gyeonggi-do (KR)

(73) Assignee: SAMSUNG ELECTRO-MECHANICS CO., LTD., Gyunggi-do (KR)

(21) Appl. No.: 13/626,783

(22) Filed: Sep. 25, 2012

(30) Foreign Application Priority Data
Sep. 27, 2011 (KR) 10-2011-0097815

(51) Int. Cl. H02J 7/00

(52) U.S. Cl. 320/108

(57) ABSTRACT

Disclosed herein is a wireless power transmission system, including a transmitting unit generating and transmitting power for charging a battery; a receiving unit receiving transmitted power and charging the battery with power; and a transmission control unit controlling a magnetic induction method and a magnetic resonance method to be selectively used according to a distance between the transmitting unit and the receiving unit when the transmitting unit transmits power.

### CROSS REFERENCE(S) TO RELATED APPLICATIONS

This application claims the benefit under 35 U.S.C. Section 119 of Korean Patent Application Serial No. 10-2011-0097815, entitled “Wireless Power Transmission System” filed on Sep. 27, 2011, which is hereby incorporated by reference in its entirety into this application.

### BACKGROUND OF THE INVENTION

1. Technical Field

The present invention relates to a wireless power transmission system, and more particularly, to a wireless power transmission system that wirelessly charges a battery for driving an electronic device.

2. Description of the Related Art

Development of wireless communication technology has resulted in a ubiquitous information environment in which anyone can transmit and receive any desired information at any time anywhere. However, most of the communication information devices have mainly depended on batteries, and are supplied with power through wired power cords, and thus communication information devices are limited due to the above reasons.

Therefore, a wireless information network environment cannot be really free without solving a problem of power for terminals.

To solve the problem, many methods of wirelessly transmitting power have been developed, including a microwave receiving method using microwave, a magnetic induction method using a magnetic field, or a magnetic resonance method using an energy converted between the magnetic field and an electric field.

In this regard, the microwave receiving method radiates microwave into air via an antenna, thereby advantageously transmitting power to a far distance, whereas the microwave receiving method causes an increase in radiation loss in the air, and thus power transmission efficiency is limited.

Further, the advantage of the magnetic induction method, which is technology of using a magnetic energy coupling coefficient by using a primary coil as a transmitter and a secondary coil as a receiver, exhibits high power transmission efficiency, whereas the disadvantage thereof is that the primary and secondary coils are need to be adjacent to each other with a short distance of several of mm to transmit power, and power transmission efficiency rapidly changes according to an arrangement of the primary and secondary coils.

Therefore, the magnetic resonance method that is similar to the magnetic induction method but transmits power as magnetic energy by focusing energy at a specific resonance frequency using a coil type inductor L and a capacitor C has been recently developed. Although the advantage of the magnetic resonance method is to transmit relatively high energy several meters, a high quality factor is required. That is, the disadvantage of the magnetic resonance method is that power transmission efficiency rapidly changes according to whether impedances match, and resonance frequencies are identical.

Accordingly, a wireless power transmission system that is a combination of the advantages of the magnetic induction method and the magnetic resonance method by adopting an advantage of the magnetic induction method when transmission and receiving coils have a short distance therebetween, and an advantage of the magnetic resonance method when transmission and receiving coils have a long distance therebetween has been proposed.

### SUMMARY OF THE INVENTION

An object of the present invention is to provide a wireless power transmission system that selectively uses a magnetic induction method and a magnetic resonance method according to a distance (a magnetic coupling coefficient) between transmission and receiving coils, thereby increasing efficiency of the wireless power transmission system.

According to an exemplary embodiment of the present invention, there is provided a wireless power transmission system, including: a transmitting unit generating and transmitting power charging a battery; a receiving unit receiving the transmitted power and charging the battery with the power; and a transmission control unit controlling a magnetic induction method and a magnetic resonance method to be selectively used according to a distance between the transmitting unit and the receiving unit when the transmitting unit transmits power.

The transmission control unit may control the magnetic induction method to be used if the distance between the transmitting unit and the receiving unit is shorter than a previously set reference distance when the transmitting unit transmits power, and the transmission control unit may control the magnetic resonance method to be used if the distance between the transmitting unit and the receiving unit is longer than the previously set reference distance when the transmitting unit transmits power.

The transmitting unit may include a power generator generating power for charging the battery; and a power transmitter transmitting the generated power.

The power transmitter may include a variable capacitor whose capacitance varies according to an applied control signal; and a transmission inductor.

The variable capacitor may include a plurality of capacitors connected in parallel to each other; and a plurality of switches connected in series to the plurality of capacitors, respectively.

The transmission control unit may include a detector detecting a magnetic coupling coefficient corresponding to the distance between the transmitting unit and the receiving unit when the transmitting unit transmits power; and a transmission controller controlling the magnetic induction method and the magnetic resonance method to be selectively used according to the detected magnetic coupling coefficient.

The detector may include one selected from the group consisting of a power sensor that detects an amount of power transmitted to the transmission inductor and a current sensor that detects a current flowing through the transmission inductor.

The transmission controller may detect the magnetic coupling coefficient corresponding to the distance between the transmitting unit and the receiving unit by using the amount of power detected by the power sensor or the current detected by the current sensor, and control the magnetic induction method and the magnetic resonance method to be selectively used according to the detected magnetic coupling coefficient.

The magnetic coupling coefficient may be inversely proportional to the amount of power detected by the power sensor or an intensity of current detected by the current sensor.

The transmission controller may vary the capacitance of the variable capacitor according to the detected magnetic coupling coefficient, and control the magnetic induction method and the magnetic resonance method to be selectively used according to the varied capacitance of the variable capacitor.

If the detected magnetic coupling coefficient is smaller than a reference magnetic coupling coefficient, the transmission controller may control the magnetic resonance method to be used by varying the capacitance of the variable capacitor smaller than a reference capacitance and, and if the detected magnetic coupling coefficient is larger than the reference magnetic coupling coefficient, the transmission controller may control the magnetic induction method to be used by varying the capacitance of the variable capacitor larger than the reference capacitance.

The transmission controller may output a control signal for selectively connecting the plurality of switches in order to vary the capacitance of the variable capacitor according to the detected magnetic coupling coefficient.

The power transmitter may include a variable transformer varying a primary turn number or a secondary turn number according to an applied control signal; a transmission capacitor disposed at the rear end of the variable transformer; and a transmission inductor.

The variable transformer may include a plurality of primary and secondary windings; and a plurality of switches connected in series to the plurality of primary windings or the plurality of secondary windings, respectively.

The transmission control unit may include a detector detecting the magnetic coupling coefficient corresponding to the distance between the transmitting unit and the receiving unit when the transmitting unit transmits power; and a transmission controller controlling the magnetic induction method and the magnetic resonance method to be selectively used according to the detected magnetic coupling coefficient.

The transmission controller may vary the primary turn number or the secondary turn number of the variable transformer according to the detected magnetic coupling coefficient, and control magnetic induction method and the magnetic resonance method to be selectively used according to the varied primary turn number or secondary turn number of the variable transformer.

If the detected magnetic coupling coefficient is smaller than a reference magnetic coupling coefficient, the transmission controller may control the magnetic resonance method to be used by reducing the primary turn number of the variable transformer, and if the detected magnetic coupling coefficient is larger than the reference magnetic coupling coefficient, the transmission controller may control the magnetic induction method to be used by increasing the primary turn number of the variable transformer.

If the detected magnetic coupling coefficient is smaller than the reference magnetic coupling coefficient, the transmission controller may control the magnetic resonance method to be used by increasing the secondary turn number of the variable transformer, and if the detected magnetic coupling coefficient is larger than the reference magnetic coupling coefficient, the transmission controller may control the magnetic induction method to be used by reducing the secondary turn number of the variable transformer.

The transmission controller may output a control signal for selectively connecting the plurality of switches in order to vary the primary turn number or the secondary turn number of the variable transformer according to the detected magnetic coupling coefficient.

### BRIEF DESCRIPTION OF THE DRAWINGS

FIG. 1 is a block diagram showing a wireless power transmission system according to an exemplary embodiment of the present invention;

FIG. 2 is a graph of showing variation of a magnetic coupling coefficient according to a distance between a transmitting unit and a receiving unit;

FIG. 3 is a graph of a power transmission factor according to a magnetic coupling coefficient in a magnetic induction method;

FIG. 4 is a graph of a power transmission factor according to a magnetic coupling coefficient in a magnetic resonance method;

FIG. 5 is a diagram of the inside of a variable capacitor of FIG. 1;

FIG. 6 is a detailed diagram of a variable capacitor for selectively using a magnetic induction method and a magnetic resonance method;

FIG. 7 is a block diagram showing a wireless power transmission system according to another exemplary embodiment of the present invention;

FIG. 8 is a detailed diagram of a variable transformer including switches and primary windings of FIG. 7; and

FIG. 9 is a detailed diagram of a variable transformer including switches and secondary windings of FIG. 7.

### DESCRIPTION OF THE PREFERRED EMBODIMENTS

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

Therefore, the configurations described in the embodiments and drawings of the present invention are merely most preferable embodiments but do not represent all of the technical spirit of the present invention. Thus, the present invention should be construed as including all the changes, equivalents, and substitutions included in the spirit and scope of the present invention at the time of filing this application.

Hereinafter, exemplary embodiments of the present invention will be described in detail with reference to the accompanying drawings.

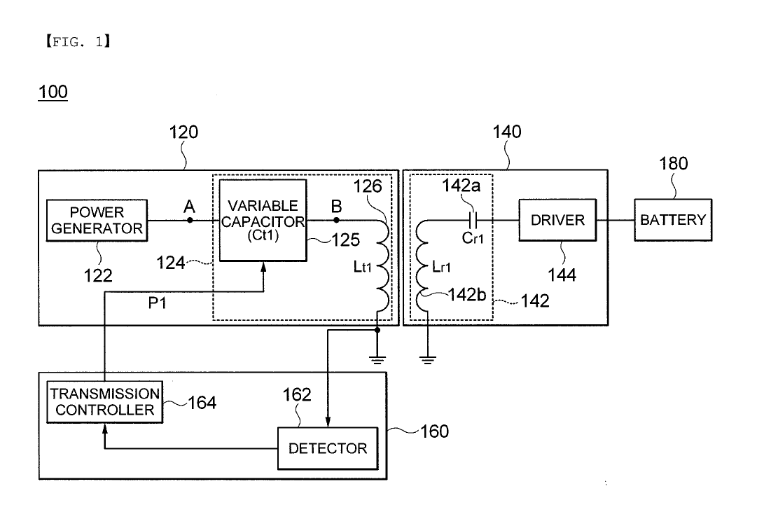

FIG. 1 is a block diagram showing a wireless power transmission system 100 according to an exemplary embodiment of the present invention.

Referring to FIG. 1, the wireless power transmission system 100 includes a transmitting unit 120 that generates power for charging a battery 180 and transmits the power to a receiving unit 140, and the receiving unit 140 that receives the power transmitted from the transmitting unit 120 and charges the battery 180 with the power.

The transmitting unit 120 may include a power generator 122 and a power transmitter 124.

The power generator 122 that generates and outputs power for charging the battery 180 may generate and output high frequency power in a range of about several tens of kHz to about several tens of MHz.

The power transmitter 124 that is used to wirelessly transmit power generated by the power generator 122 to the receiving unit 140 may include a variable capacitor 125 whose capacitance varies according to an applied control signal P1 and a transmission inductor 126.

In this regard, the variable capacitor 125 may include a plurality of capacitors 125a1˜125an connected in parallel to each other and a plurality of switches 125b1˜125b2 connected in series to the capacitors 125a1˜125an, respectively. A detailed operation of the variable capacitor 125 will be described in more detail below.

The receiving unit 140 may include a power receiver 142 and a driver 144.

In this regard, the power receiver 142 includes a receiving capacitor 142a and a receiving inductor 142b that receives the power transmitted from the transmitting unit 120. The driver 144 may be configured to transmit power received in the power receiver 142 to the battery 180 directly or by changing a level of the power.

Meanwhile, the wireless power transmission system 100 further includes a transmission control unit 160 that controls a magnetic induction method and a magnetic resonance method to be selectively used according to a distance between the transmitting unit 120 and the receiving unit 140 when the transmitting unit 120 transmits power.

In this regard, the transmission control unit 160 controls the magnetic induction method to be used if the distance between the transmitting unit 120 and the receiving unit 140 is shorter than a previously set reference distance, and controls the magnetic resonance method to be used if the distance between the transmitting unit 120 and the receiving unit 140 is longer than the previously set reference distance.

More specifically, the transmission control unit 160 detects a magnetic coupling coefficient K corresponding to the distance between the transmitting unit 120 and the receiving unit 140, and controls the magnetic induction method and the magnetic resonance method to be selectively used according to the magnetic coupling coefficient K detected when the transmitting unit 120 transmits power.

An operating principle of transmitting power by selectively using the magnetic induction method and the magnetic resonance method according to the magnetic coupling coefficient K will now be described below.

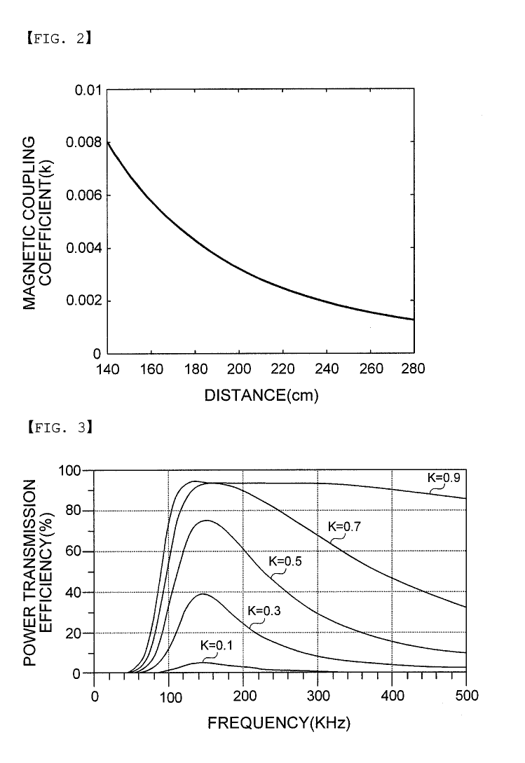

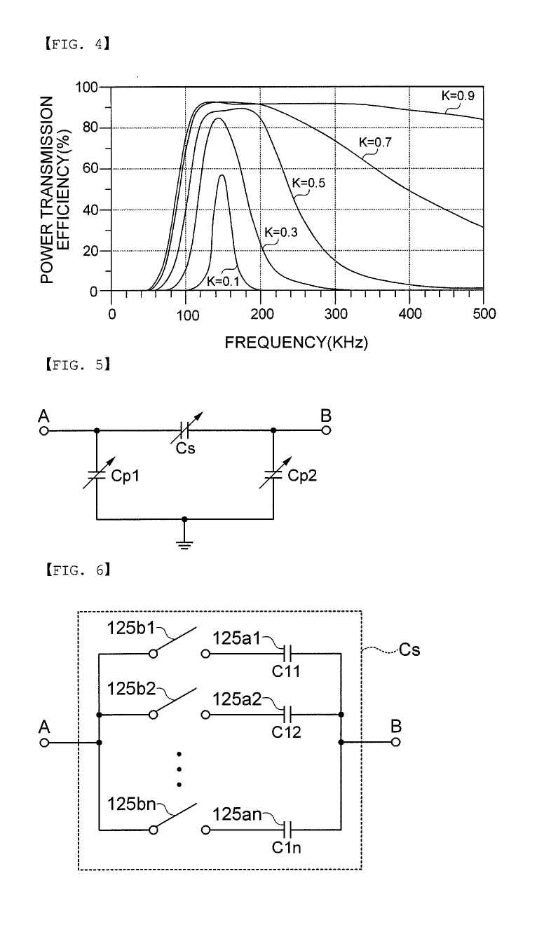

FIG. 2 is a graph showing variation of a magnetic coupling coefficient according to a distance between the transmitting unit 120 and the receiving unit 140. FIG. 3 is a graph showing power transmission according to a magnetic coupling coefficient in a magnetic induction method. FIG. 4 is a graph showing power transmission according to a magnetic coupling coefficient in a magnetic resonance method.

Referring to FIGS. 2 to 4, energy coupled according to a distance between the transmitting unit 120 that transmits power (energy) to the receiving unit 140 and the receiving unit 140 that receives power (energy) transmitted from the transmitting unit 120 differs, and thus a mutual inductance M changes.

To explain this principle, input impedance Zin of the transmitting unit 120 may be calculated by using Equations 1 to 4 below,

$$\begin{matrix}{Z}_{i n} = {Z}_{t 1} + \frac{{( ω \cdot M )}^{2}}{{Z}_{r 1} + {Z}_{L}} & [ Equation 1 ] \\ {Z}_{t 1} = {sL}_{t 1} + \frac{1}{{sC}_{t 1}} & [ Equation 2 ] \\ {Z}_{r 1} = {sL}_{r 1} + \frac{1}{{sC}_{r 1}} & [ Equation 3 ] \\ M = k \sqrt{{L}_{t 1} \cdot {L}_{r 1}} & [ Equation 4 ]\end{matrix}$$

wherein, Cₜ₁ denotes a transmission capacitor, Lₜ₁ denotes a transmission inductor, Cᵣ₁ denotes a receiving capacitor, Lᵣ₁ denotes a receiving inductor, M denotes the mutual inductance, and K denotes the magnetic coupling coefficient.

If a location is displaced in the receiving unit 140, an LC value is determined by a resonance frequency as shown in Equations 1 to 4 above, the input impedance Zin is affected by the mutual inductance M, the mutual inductance M is determined by the magnetic coupling coefficient K, and thus the input impedance Zin is a function by the magnetic coupling coefficient K.

Further, as shown in FIG. 2, the farther the distance between the transmitting unit 120 and the receiving unit 140, the smaller the magnetic coupling coefficient K, and thus the input impedance Zin is reduced.

As described above, if the magnetic coupling coefficient K changes according to the distance between the transmitting unit 120 and the receiving unit 140, impedance changes according to locations of the transmission inductor and the receiving inductor, and thus an energy transmission coefficient changes.

Referring to FIG. 3, the magnetic induction method is advantageous if the distance between the transmitting unit 120 and the receiving unit 140 is shorter than a previously set reference distance, i.e., the magnetic coupling coefficient is large, since energy transmission is rapidly reduced as the magnetic coupling coefficient becomes smaller. Referring to FIG. 4, the magnetic resonance method is advantageous if the distance between the transmitting unit 120 and the receiving unit 140 is longer than the previously set reference distance, i.e., the magnetic coupling coefficient is small, since energy transmission is gradually reduced as the magnetic coupling coefficient becomes smaller.

The transmission control unit 160 may include a detector 162 and a transmission controller 164 so as to transmit power by selectively using the magnetic induction method and the magnetic resonance method according to a magnetic coupling method.

In this regard, the detector 162 that is used to detect the magnetic coupling coefficient corresponding to the distance between the transmitting unit 120 and the receiving unit 140 may include one selected from the group consisting of a power sensor that detects an amount of power transmitted to the transmission inductor 126 and a current sensor that detects a current flowing through the transmission inductor 126.

In this regard, if the detector 162 is the power sensor, when the power sensor detects a large amount of power, the receiving unit 140 is located far away from the transmitting unit 120, and thus power is not transmitted from the transmitting unit 120 to the receiving unit 140. When the power sensor detects a small amount of power, the receiving unit 140 is located adjacent to the transmitting unit 120, and thus power is transmitted from the transmitting unit 120 to the receiving unit 140.

Further, if the detector 162 is the current sensor, like the power sensor, when the current sensor detects a large amount of current, the receiving unit 140 is located far away from the transmitting unit 120, and thus power is not transmitted from the transmitting unit 120 to the receiving unit 140. When the current sensor detects a small amount of current, the receiving unit 140 is located adjacent to the transmitting unit 120, and thus power is transmitted from the transmitting unit 120 to the receiving unit 140.

The transmission controller 164 controls the magnetic induction method and the magnetic resonance method to be selectively used according to the magnetic coupling coefficient detected by the detector 162.

More specifically, the transmission controller 164 may transmit power using the magnetic resonance method if the power sensor detects a large amount of power, the receiving unit 140 is located far away from the transmitting unit 120, and thus power is not transmitted from the transmitting unit 120 to the receiving unit 140, which reduces the magnetic coupling coefficient, and may transmit power using the magnetic induction method if the power sensor detects a small amount of power, the receiving unit 140 is located adjacent to the transmitting unit 120, and thus power is transmitted from the transmitting unit 120 to the receiving unit 140, which increases the magnetic coupling coefficient.

The transmission controller 164 performs the following control operation in order to selectively use the magnetic induction method and the magnetic resonance method.

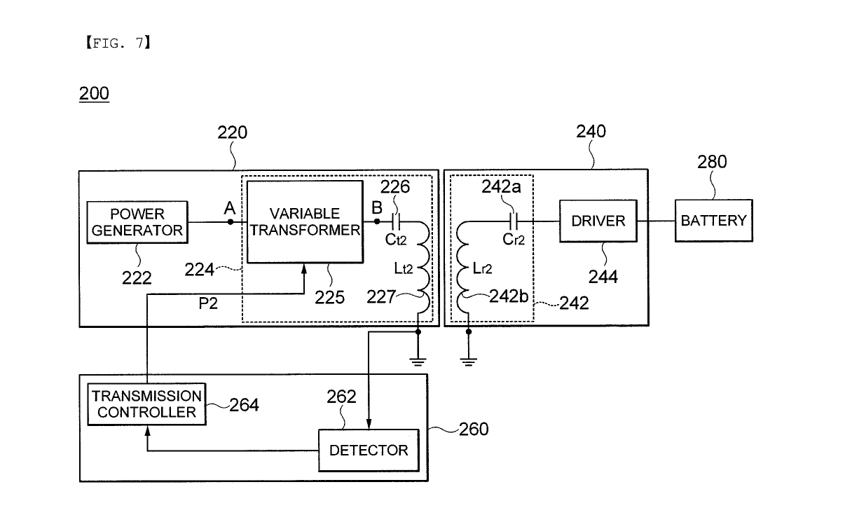

FIG. 5 is a diagram of the inside of the variable capacitor 125 of FIG. 1. FIG. 6 is a detailed diagram of the variable capacitor 125 for selectively using a magnetic induction method and a magnetic resonance method.

Before explaining an operation of the transmission controller 164, the variable capacitor 125 will now be described in more detail with reference to FIGS. 5 and 6. As shown in FIG. 5, first and second capacitors Cp1 and Cp2 may perform a resonance frequency function, and a third capacitor Cs may perform a function of selectively using the magnetic induction method and the magnetic resonance method. However, the present invention is not limited thereto. The second capacitor Cp2 may perform the function of selectively using the magnetic induction method and the magnetic resonance method. In addition, a varactor capacitor may be used as a capacitor.

As shown in FIG. 6, the third capacitor Cs may include the plurality of capacitors 125a1˜125an connected in parallel to each other and the plurality of switches 125b1˜125bn connected in series to the plurality of capacitors 125a1˜125an, respectively.

The control operation of the transmission controller 164 will now be described based on the internal construction of the variable capacitor 125. The transmission controller 164 varies a capacitance of the variable capacitor 125 according to a detected magnetic coupling coefficient, and controls the magnetic induction method and the magnetic resonance method to be selectively used according to the varied capacitance of the variable capacitor 125.

More specifically, if the detected magnetic coupling coefficient is smaller than a reference magnetic coupling coefficient, the transmission controller 164 controls the magnetic resonance method to be used by varying the capacitance of the variable capacitor 125 smaller than a reference capacitance, and if the detected magnetic coupling coefficient is larger than the reference magnetic coupling coefficient, the transmission controller 164 controls the magnetic induction method to be used by varying the capacitance of the variable capacitor 125 larger than the reference capacitance.

That is, the transmission controller 164 may output the control signal P1 for selectively connecting the plurality of switches 125b1˜125bn in order to vary the capacitance of the variable capacitor 125 according to the detected magnetic coupling coefficient.

If the detected magnetic coupling coefficient is smaller than the reference magnetic coupling coefficient (e.g., 0.5), the transmission controller 164 varies the capacitance of the variable capacitor 125 smaller than the reference capacitance by not connecting the plurality of switches 125b1˜125bn or by outputting the control signal P1 for connecting some of the switches 125b1˜125bn, and if the detected magnetic coupling coefficient is larger than the reference magnetic coupling coefficient (e.g., 0.5), the transmission controller 164 varies the capacitance of the variable capacitor 125 larger than the reference capacitance by connecting all the plurality of switches 125b1˜125bn or outputting the control signal P1 for connecting a certain number of switches 125b1˜125bn.

A wireless power transmission system according to another exemplary embodiment of the present invention will now be described below.

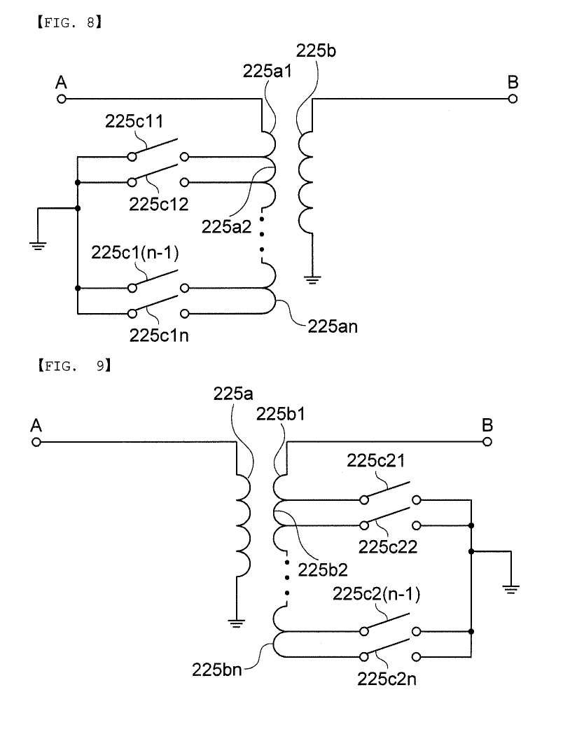

FIG. 7 is a block diagram showing a wireless power transmission system 200 according to another exemplary embodiment of the present invention. FIG. 8 is a detailed diagram of a variable transformer including switches and primary windings of FIG. 7. FIG. 9 is a detailed diagram of a variable transformer including switches and secondary windings of FIG. 7.

Referring to FIGS. 7 through 9, the wireless power transmission system 200 includes a transmitting unit 220 that generates power for charging a battery 280 and transmits power to a receiving unit 240, and the receiving unit 240 that receives the power transmitted from the transmitting unit 220 and charges the battery 280 with the power.

The transmitting unit 220 may include a power generator 222 and a power transmitter 224.

The power generator 222 that generates and outputs power for charging the battery 280 may generate and output high frequency power in a range of about several tens of kHz to about several tens of MHz.

The power transmitter 224 that is used to wirelessly transmit the power generated by the power generator 222 to the receiving unit 240 may include a variable transformer 225 that varies a primary turn number or a secondary turn number according to an applied control signal P2, a transmission capacitor 226 that is disposed at the rear end of the variable transformer 225, and a transmission inductor 227.

In this regard, the variable transformer 225 performs impedance matching, and may include a plurality of primary and secondary windings 225 (225a1˜225an) and 225b (225b1˜225bn) and a plurality of switches 225c connected in series to the primary windings 225 (225a1˜225an) or the secondary windings 225b (225b1˜225bn), respectively.

The receiving unit 240 may include a power receiver 242 and a driver 244.

In this regard, the power receiver 242 includes a receiving capacitor 242a and a receiving inductor 242b that receives power transmitted from the transmitting unit 220. The driver 244 may be configured to transmit power received in the power receiver 242 to the battery 280 directly or by changing a level of power.

Meanwhile, the wireless power transmission system 200 further includes a transmission control unit 260 that controls a magnetic induction method and a magnetic resonance method to be selectively used according to a distance between the transmitting unit 220 and the receiving unit 240 when the transmitting unit 220 transmits power.

The transmission control unit 260 includes a detector 262 and a transmission controller 264.

Among others, the detector 262 detects a magnetic coupling coefficient corresponding to a distance between the transmitting unit 220 and the receiving unit 240.

The detector 262 that is used to detect a magnetic coupling coefficient corresponding to a distance between the transmitting unit 220 and the receiving unit 240 may include one selected from the group consisting of a power sensor that detects an amount of power transmitted to the transmission inductor 227 and a current sensor that detects a current flowing through the transmission inductor 227.

The transmission controller 264 controls the magnetic induction method and the magnetic resonance method to be selectively used according to the detected magnetic coupling coefficient. That is, the transmission controller 264 varies the primary turn number 225 (225a1˜225an) or the secondary turn number 225b (225b1˜225bn) of the variable transformer 225 according to the detected magnetic coupling coefficient, and controls the magnetic induction method and the magnetic resonance method to be selectively used according to the varied primary turn number 225 (225a1˜225an) or secondary turn number 225b (225b1˜225bn) of the variable transformer 225.

More specifically, as shown in FIG. 8, if the detected magnetic coupling coefficient is smaller than a reference magnetic coupling coefficient, the transmission controller 264 controls the magnetic resonance method to be used by reducing the primary turn number 225 (225a1˜225an) of the variable transformer 225, and if the detected magnetic coupling coefficient is larger than the reference magnetic coupling coefficient, the transmission controller 264 controls the magnetic induction method to be used by increasing the primary turn number 225 (225a1˜225an) of the variable transformer 225.

Further, as shown in FIG. 9, if the detected magnetic coupling coefficient is smaller than the reference magnetic coupling coefficient, the transmission controller 264 controls the magnetic resonance method to be used by increasing the secondary turn number 225b (225b1˜225bn) of the variable transformer 225, and if the detected magnetic coupling coefficient is larger than the reference magnetic coupling coefficient, the transmission controller 264 controls the magnetic induction method to be used by reducing the secondary turn number 225b (225b1˜225bn) of the variable transformer 225.

The transmission controller 264 may output the control signal P2 for selectively connecting a plurality of switches in order to vary the primary turn number 225 (225a1˜225an) or the secondary turn number 225b (225b1˜225bn) of the variable transformer 225 according to the detected magnetic coupling coefficient. That is, the transmission controller 264 selectively connects a plurality of first switches 225c11˜225c1n in order to vary the primary turn number 225 (225a1˜225an) of the variable transformer 225 according to the detected magnetic coupling coefficient, and selectively connects a plurality of second switches 225c21˜225c2n in order to vary the secondary turn number 225b (225b1˜225bn) of the variable transformer 225 according to the detected magnetic coupling coefficient.

As described above, a magnetic induction method or a magnetic resonance method is appropriately used according to a magnetic coupling coefficient between a transmitting unit and a receiving unit, thereby always increasing efficiency of a wireless power transmission system regardless of a distance (a location) between the transmitting unit and the receiving unit.

As described above, the wireless power transmission system according to the exemplary embodiment of the present invention appropriately uses a magnetic induction method and a magnetic resonance method according to a distance (a magnetic coupling coefficient) between transmission and receiving coils, thereby increasing efficiency of the wireless power transmission system.

More specifically, the wireless power transmission system uses the magnetic induction method when the distance between transmission and receiving coils is short and uses the magnetic resonance method when the distance between transmission and receiving coils is long, thereby increasing freedom of a location, and enhancing performance of efficiency.

Accordingly, reliability of the wireless power transmission system can be advantageously enhanced.

Although the exemplary embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A wireless power transmission system, comprising:
a transmitting unit generating and transmitting power for charging a battery;
a receiving unit receiving the transmitted power and charging the battery with power; and
a transmission control unit controlling a magnetic induction method and a magnetic resonance method to be selectively used according to a distance between the transmitting unit and the receiving unit when the transmitting unit transmits power.

2. The wireless power transmission system according to claim 1, wherein the transmission control unit controls the magnetic induction method to be used if the distance between the transmitting unit and the receiving unit is shorter than a previously set reference distance when the transmitting unit transmits the power, and
the transmission control unit controls the magnetic resonance method to be used if the distance between the transmitting unit and the receiving unit is longer than the previously set reference distance when the transmitting unit transmits power.

3. The wireless power transmission system according to claim 1, wherein the transmitting unit includes:
a power generator generating power for charging the battery; and
a power transmitter transmitting the generated power.

4. The wireless power transmission system according to claim 3, wherein the power transmitter includes:
a variable capacitor whose capacitance varies according to an applied control signal; and
a transmission inductor.

5. The wireless power transmission system according to claim 4, wherein the variable capacitor includes:
a plurality of capacitors connected in parallel to each other; and
a plurality of switches connected in series to the plurality of capacitors, respectively.

6. The wireless power transmission system according to claim 5, wherein the transmission control unit includes:
a detector detecting a magnetic coupling coefficient corresponding to the distance between the transmitting unit and the receiving unit when the transmitting unit transmits power; and
a transmission controller controlling the magnetic induction method and the magnetic resonance method to be selectively used according to the detected magnetic coupling coefficient.

7. The wireless power transmission system according to claim 6, wherein the detector includes one selected from the group consisting of a power sensor that detects an amount of power transmitted to the transmission inductor and a current sensor that detects a current flowing through the transmission inductor.

8. The wireless power transmission system according to claim 7, wherein the transmission controller detects the magnetic coupling coefficient corresponding to the distance between the transmitting unit and the receiving unit by using the amount of power detected by the power sensor or the current detected by the current sensor, and controls the magnetic induction method and the magnetic resonance method to be selectively used according to the detected magnetic coupling coefficient.

9. The wireless power transmission system according to claim 8, wherein the magnetic coupling coefficient is inversely proportional to the amount of power detected by the power sensor or an intensity of current detected by the current sensor.

10. The wireless power transmission system according to claim 8, wherein the transmission controller varies the capacitance of the variable capacitor according to the detected magnetic coupling coefficient, and controls the magnetic induction method and the magnetic resonance method to be selectively used according to the varied capacitance of the variable capacitor.

11. The wireless power transmission system according to claim 10, wherein if the detected magnetic coupling coefficient is smaller than a reference magnetic coupling coefficient, the transmission controller controls the magnetic resonance method to be used by varying the capacitance of the variable capacitor smaller than a reference capacitance and, if the detected magnetic coupling coefficient is larger than the reference magnetic coupling coefficient, the transmission controller controls the magnetic induction method to be used by varying the capacitance of the variable capacitor larger than the reference capacitance.

12. The wireless power transmission system according to claim 10, wherein the transmission controller outputs a control signal for selectively connecting the plurality of switches in order to vary the capacitance of the variable capacitor according to the detected magnetic coupling coefficient.

13. The wireless power transmission system according to claim 3, wherein the power transmitter includes:
a variable transformer varying a primary turn number or a secondary turn number according to an applied control signal;
a transmission capacitor disposed at the rear end of the variable transformer; and
a transmission inductor.

14. The wireless power transmission system according to claim 13, wherein the variable transformer includes:
a plurality of primary and secondary windings; and
a plurality of switches connected in series to the plurality of primary windings or the plurality of secondary windings, respectively.

15. The wireless power transmission system according to claim 14, wherein the transmission control unit comprises:
a detector detecting the magnetic coupling coefficient corresponding to the distance between the transmitting unit and the receiving unit when the transmitting unit transmits power; and
a transmission controller controlling the magnetic induction method and the magnetic resonance method to be selectively used according to the detected magnetic coupling coefficient.

16. The wireless power transmission system according to claim 15, wherein the transmission controller varies the primary turn number or the secondary turn number of the variable transformer according to the detected magnetic coupling coefficient, and controls magnetic induction method and the magnetic resonance method to be selectively used according to the varied primary turn number or secondary turn number of the variable transformer.

17. The wireless power transmission system according to claim 16, wherein if the detected magnetic coupling coefficient is smaller than a reference magnetic coupling coefficient, the transmission controller controls the magnetic resonance method to be used by reducing the primary turn number of the variable transformer, and if the detected magnetic coupling coefficient is larger than the reference magnetic coupling coefficient, the transmission controller controls the magnetic induction method to be used by increasing the primary turn number of the variable transformer.

18. The wireless power transmission system according to claim 16, wherein if the detected magnetic coupling coefficient is smaller than the reference magnetic coupling coefficient, the transmission controller controls the magnetic resonance method to be used by increasing the secondary turn number of the variable transformer, and if the detected magnetic coupling coefficient is larger than the reference magnetic coupling coefficient, the transmission controller controls the magnetic induction method to be used by reducing the secondary turn number of the variable transformer.

19. The wireless power transmission system according to claim 16, wherein the transmission controller outputs a control signal for selectively connecting the plurality of switches in order to vary the primary turn number or the secondary turn number of the variable transformer according to the detected magnetic coupling coefficient.
